(19) United States
(12) Patent Application Publication
(10) Pub. No.: US 2019/0161189 A1
(43) Pub. Date: May 30, 2019

(54) Air Drop Platform Alignment Device

(71) Applicant: Capewell Aerial Systems LLC, South Windsor, CT (US)

(72) Inventor: Stephen T. Parkinson, Suffield, CT (US)

(21) Appl. No.: 16/181,989

(22) Filed: Nov. 6, 2018

Related U.S. Application Data
(60) Provisional application No. 62/591,415, filed on Nov. 28, 2017.

(51) Int. Cl. B64D 1/12

(52) U.S. Cl. CPC B64D 1/12

(57) ABSTRACT

An air drop platform alignment device employs an anchor which is attached to a platform. A release mechanism is triggerable during aerial delivery to release the anchor from the platform. The anchor functions to rotate the platform so that it is aligned in a direction away from the cross-wind prior to landing, thereby decreasing the likelihood that the platform will roll over. The release mechanism may be automatically triggered by opening a parachute attached to the platform, by the platform reaching a pre-established altitude, by triggering from a remote device or by a timer at a pre-established time. The anchor, in one embodiment, is configured to dig into the ground, and in another embodiment, is configured to drag across the ground prior to impact of the platform on the ground.

### CROSS-REFERENCE TO RELATED APPLICATION

This application claims the priority of U.S. Provisional Patent Application No. 62/591,415 filed on Nov. 28, 2017, the entirety of which application is incorporated herein by reference.

### BACKGROUND

A variety of equipment is dropped from military aircraft by parachute. In many instances this is done by a platform that supports the equipment and is attached to a parachute system. Parachutes are used both to extract the platform from the aircraft and to support the platform during its descent.

Platforms are of a fixed width to fit the aircraft cargo handling system, but of variable length to permit various payload weights to be used. The choice of platform length is generally dictated by: availability, payload size, payload mass, and aircraft volume. In most cases the platform is much longer than it is wide.

The parachute connection to the platform involves a single point attachment, which permits the platform to swivel freely or be restrained, as the platform descends. Platforms may or may not have built in energy absorption to minimize the shock of ground impact.

For conventional cargo air drops, the aircraft generally flies into the wind when initiating the air drop. The platform inevitably rotates during its descent from the aircraft and can orient in any direction with respect to ground wind speed. When there is a high wind speed (greater than 7-10 knots), there is a risk of the platform landing cross wind and rolling, thereby damaging the payload or rendering the payload inoperative or useless.

Devices exist to improve the rollover resistance during cross wind landing. For example, mechanical outriggers are used to provide a counter moment. Outriggers are stowed to allow them to fit an aircraft. After launch, they drop to a horizontal position and lock to increase the ground footprint. Outriggers tend to add significant cost and complication to the system.

Rollover of aerial delivery platforms is a known problem. It is countered by placing limitations on the operating envelope (restricting aerial delivery in high ground wind) or by mechanical devices which add excessive weight and high cost to the system. A need exists for an improved rollover aerial delivery platform that takes up less space and minimizes cost and weight.

### SUMMARY

Briefly stated, an air drop platform alignment device is used during an aerial delivery from an aircraft. The alignment device comprises an anchor which is attached to an alignment point of the platform by a tether. A release mechanism is triggerable to release the anchor from the platform. During aerial delivery, the release mechanism and triggering anchor triggers. The release mechanism releases the anchor and the anchor causes the platform to rotate so that the platform is aligned into a non-cross wind direction prior to a landing of the platform. The anchor further comprises a digging device for soft ground. In another embodiment, the anchor comprises a high drag element for hard ground.

The release mechanism is automatically triggered by opening a parachute attached to the platform, in one embodiment. In another embodiment, the release mechanism is automatically triggered by the platform reaching a pre-established altitude. The release mechanism may also be manually triggered from a remote device. In another embodiment, the release mechanism is automatically triggered by a timer. In one embodiment for triggering the release, the remote device is a cell phone.

In one preferred embodiment, a storage receptacle is disposed on the platform and the anchor is disposed in the receptacle. The storage receptacle is disposed at an end location of the platform.

A method of aligning a platform during an aerial delivery comprises connecting an anchor to the platform, stowing the anchor in a releasable receptacle, extracting the platform from an aircraft, releasing the receptacle to eject the anchor from the platform so that the anchor makes a ground impact prior to the platform and aligning the platform away from a cross-wind direction.

The method also comprises automatically releasing the anchor in response to opening the parachute or alternatively comprises automatically releasing the anchor upon obtainment of a pre-established altitude by the platform. The methods may also comprise automatically releasing the anchor at a pre-established time. In one embodiment, the method comprises releasing the anchor in response to a signal from a cell phone.

The alignment method also comprises engaging the anchor into the ground or dragging the anchor across the ground.

### BRIEF DESCRIPTION OF THE DRAWINGS

FIG. 1 is a schematic time-lapse front view of a prior art air drop platform alignment device in successive states of rollover;

FIG. 2 is a partially schematic isometric view of an air drop platform alignment device according to the disclosure; and

FIG. 3 is a block diagram of various possible triggers for the release mechanism of an air drop platform alignment device according to the disclosure.

### DETAILED DESCRIPTION

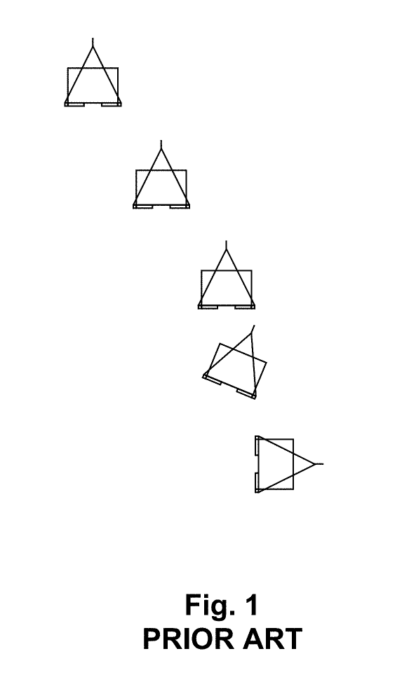

A first embodiment of an air drop platform alignment device 10 according to the disclosure will be discussed with reference to FIGS. 1-3.

Referring to FIG. 1, existing cross wind landing performance enhancers do not align the platform prior to landing on the ground. With a side or cross wind, the platform risks rollover when the platform broadside is parallel to the wind.

The alignment device 10 orients the platform in the best condition for rollover prevention before ground impact. A platform landing longitudinally into wind has higher rollover resistance than a platform landing cross wind, because the energy required to overturn is greater and the resistance to overturning is greater. This could be achieved by use of real time GPS analysis to determine orientation to ground and firing thrusters, or by the use of a ground anchor dropped from the platform before impact to rotate the platform as disclosed herein.

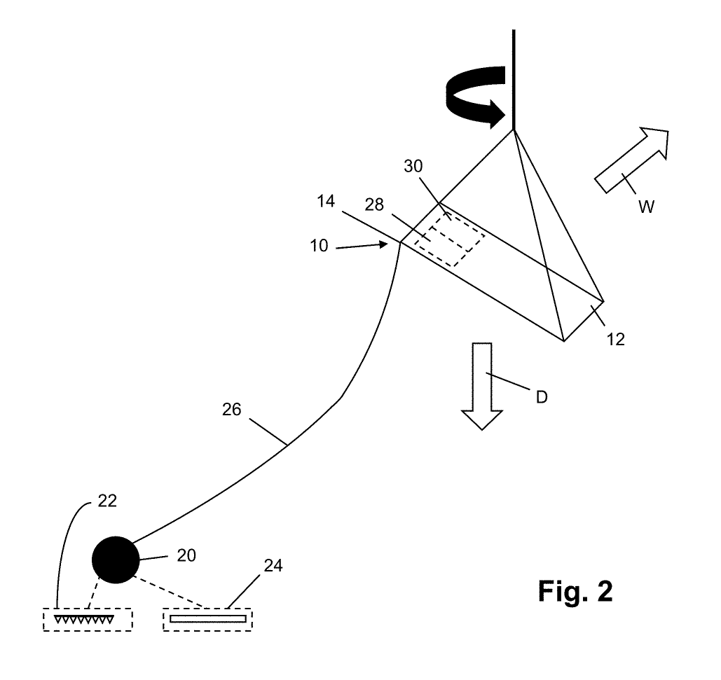

Referring to FIG. 2, the alignment device 10 has an anchor 20 that is dropped before the platform 12 impacts the ground. The anchor 20 is mounted to the platform 12 at alignment point 14. This alignment point 14 is determined based on the physical properties of the platform 12, for example, the wind speed and direction, the flight speed and direction, and any relevant landing zone conditions. The location of the alignment point 14 is specifically chosen such that the platform 12 is most often oriented into the wind. This maximizes the resistance to rollover of the platform 12 and thereby extends the safe operating envelope of aerial delivery. As the platform 12 travels in the descent direction D, the anchor 20 rotates the platform 12 away from a direction perpendicular to the wind direction W.

The anchor 20 has a digging component 22 for soft ground and a high drag element 24 for hard ground. The anchor 20 is connected to the platform 12 by a tether 26. The tether 26 may be made from elastic or inelastic material and may include a break tie.

A stowage receptacle 28 for the anchor is located at one end of the platform 12. This allows the anchor 20 to not take up any additional space in the aircraft prior to release of the platform 12. The receptacle may have an ejector 29 to facilitate ejecting or dropping the anchor from the platform. A release mechanism 30 rejects or drops the anchor 20. This may be accomplished by unlatching a door, cover or side of the receptacle.

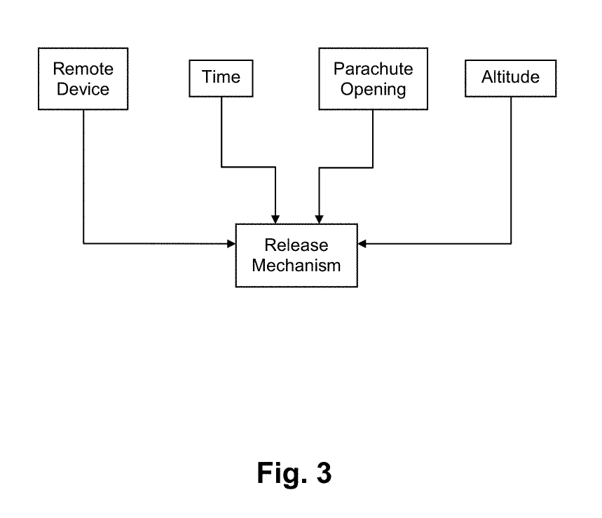

Referring to FIG. 3, this release mechanism 30 may be triggered automatically by the main parachute opening or other operating conditions such as altitude of the platform 12. The release mechanism may be automatically triggered at a pre-established time or elapsed time by a timer. The release mechanism 30 may also be manually triggered from a remote device, such as a cell phone.

The disclosed air drop platform alignment device 10 has been described in the context of a specific application, but those skilled in the art will recognize other uses. Those skilled in the art will also recognize simple modifications to achieve the same or similar functionality. The description is by way of illustration and not limitation.

While preferred embodiments of the foregoing invention have been set forth for purposes of illustration, the foregoing description should not be deemed a limitation of the invention herein. Accordingly, various modifications, adaptations and alternatives may occur to one skilled in the art without departing from the spirit and the scope of the present invention.

1. An air drop platform alignment device for use during an aerial delivery from an aircraft, said alignment device comprising:
an anchor attached to an alignment point of a platform by a tether; and
a release mechanism triggerable to release the anchor from the platform;
wherein during aerial delivery, the release mechanism is triggered to release the anchor and cause the platform to align in a non-cross wind direction prior to a landing of the platform.

2. The alignment device of claim 1 wherein said anchor further comprises a digging device for soft ground.

3. The alignment device of claim 1 wherein said anchor further comprises a high drag element for hard ground.

4. The alignment device of claim 1 wherein said release mechanism is automatically triggered by opening a parachute attached to the platform.

5. The alignment device of claim 1 wherein said release mechanism is automatically triggered by the platform reaching a pre-established altitude.

6. The alignment device of claim 1 wherein said release mechanism is manually triggered from a remote device.

7. The alignment device of claim 1 wherein said release mechanism is automatically triggered by a timer.

8. The alignment device of claim 1 further comprising a storage receptacle disposed on said platform and said anchor is disposed in said receptacle.

9. The alignment device of claim 8 wherein said storage receptacle is disposed at an end location of said platform.

10. The alignment device of claim 6 wherein the remote device is a cell phone.

11. A method of aligning a platform during an aerial delivery comprising:
connecting an anchor to the platform;
stowing the anchor in a releasable receptacle;
extracting the platform from an aircraft;
releasing the receptacle to eject the anchor from the platform so that the anchor makes a ground impact prior to the platform; and
aligning the platform away from a cross-wind direction.

12. The alignment method of claim 11 further comprising automatically releasing the anchor in response to opening the parachute.

13. The alignment method of claim 11 further comprising automatically releasing the anchor upon obtainment of a pre-established altitude by the platform.

14. The alignment method of claim 1 further comprising automatically releasing the anchor at a pre-established time.

15. The alignment method of claim 11 further comprising releasing the anchor in response to a signal from a cell phone.

16. The alignment method of claim 11 further comprising engaging the anchor into the ground.

17. The alignment method of claim 11 further comprising dragging the anchor across the ground.
